(19) United States
(12) Patent Application Publication
(10) Pub. No.: US 2015/0347447 A1
(43) Pub. Date: Dec. 3, 2015

(54) Method and architecture for synchronizing files

(71) Applicant: Acer Cloud Technology Inc., Sunnyvale, CA (US)

(72) Inventors: W. Wilson Ho, San Mateo, CA (US); David Edward Hirsch, Sunnyvale, CA (US); Yuk Kwai Lee, Fremont, CA (US); Raymond Lo, Mountain View, CA (US); Steve Jason Onorato, Cupertino, CA (US)

(73) Assignee: Acer Cloud Technology Inc., Sunnyvale, CA (US)

(21) Appl. No.: 14/288,378

(22) Filed: May 27, 2014

(51) Int. Cl. G06F 17/30

(52) U.S. Cl. CPC G06F 17/30174; G06F 17/30209; G06F 17/30082; G06F 17/30088

(57) ABSTRACT

Techniques for providing pervasive synchronization services to digital assets are described. With the synchronization services, copies of a digital asset, regardless where they are physically located as long as they are in predefined or registered storage area (e.g., a folder or repository), are kept synchronized. In other words, when one has made a change to a file on one computer, copies of the file distributed on other computers are all updated with the change. The pervasive synchronization services are performed by using metadata sets of the digital assets without releasing the content of the digital assets. A metadata set includes some or all of header information of a file holding a digital asset and supplemental information generated about the file, wherein the supplemental information includes at least location information to indicate where there are copies of the file. The location information facilitates a computing device to synchronize all the copies of the file with a change made by a user to one of the copies.

### BACKGROUND OF THE INVENTION

1. Field of the Invention

The present invention is related to the area of protecting data in a predefined setting (e.g., an enterprise environment), and more particularly, related to processes, systems, architectures and software products for providing pervasive security and synchronization to digital assets at all times without the content of the digital assets leaving beyond the predefined setting.

2. Description of Related Art

The Internet is the fastest growing telecommunications medium in history. This growth and the easy access it affords have significantly enhanced the opportunity to use advanced information technology for both the public and private sectors. It provides unprecedented opportunities for interaction and data sharing among businesses and individuals. However, the advantages provided by the Internet come with a significantly greater element of risk to the confidentiality and integrity of information. The Internet is a widely open, public and international network of interconnected computers and electronic devices. When a project is undertaken by a group of users in several locations, a file related to the project could be altered unknowingly beyond its original intent or may be even accessed by an unauthorized person or machine from the Internet when being shared among the users.

There are many efforts in progress aimed at protecting proprietary information traveling across the Internet and controlling access to the proprietary information. For example, Dropbox (www.dropbox.com) is a free service that lets a user bring all his/her data files (e.g., photos, documents, and videos) anywhere. Any file saved to a Dropbox folder will automatically save to all computers associated with the user. In some cases, one can log into the Dropbox website to access his/her files. This means that one can start working on a computer at school or office, and finish on a home computer. There is no need to email oneself a file and bring a USB drive to carry the file.

Some business entities, however, prefer not to have a file outside their controls. Although Dropbox provides a solution to synchronize the file that can be accessed anywhere at any time, it requires a user to have a copy of the file on a server controlled by a service provider, not by a business itself that has created the file. For some highly sensitive files, it would be difficult for a business to rely on services similar to Dropbox. There is a need for solutions that can synchronize files while not releasing the files beyond the control of a business.

### SUMMARY OF INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

The present invention is related to processes, systems, architectures and software products for providing pervasive synchronization services to digital assets at all times and is particularly suitable in an enterprise environment. In general, the pervasive synchronization services mean that digital assets are synchronized at all times regardless where, when or by who a change is made to a digital asset (e.g., a document or a music file). As a result, copies of the digital asset, regardless where they are physically located as long as they are in predefined or registered storage area (e.g., a folder or repository), are kept identical. In other words, one has made a change to a file on one computer, copies of the file distributed on other computers are all updated with the change.

According to one aspect of the present invention, the pervasive synchronization services are performed by using metadata sets of the digital assets. A metadata set includes some or all of header information of a file holding a digital asset and supplemental information generated about the file, wherein the supplemental information includes at least location information to indicate where there are copies of the file. The location information facilitates a computing device to synchronize all the copies of the file with a change made by a user to one of the copies.

According to another aspect of the present invention, a computing device configured to manage the metadata sets and perform the synchronization services does not have to have a copy of the digital assets. In other words, the content of the digital assets stays where they are or within an organization (e.g., on a private network). By deploying a client module running on client devices on the private network, the registered storage area on a client device is watched for any change to a digital asset therein. Whenever there is a change to the digital asset, the client module communicates with the server to cause the corresponding metadata to be updated.

Various embodiments may be implemented as a method, a software product, a service and a part of a system. According to one embodiment, the present invention is a method for synchronizing digital assets via a server device, the method comprises: updating a metadata set of a digital asset when there is a change made to a status of the digital asset, and synchronizing the digital asset via the metadata set without releasing a copy of the digital asset to the server device. The change is detected by monitoring the status of the digital asset. The metadata set includes some or all of header information of the digital asset and supplemental information including at least a location of the digital asset.

According to another embodiment, the present invention is a system for synchronizing digital assets, the system comprises a server configured to update a metadata set of a digital asset when there is a change made to a status of the digital asset. The change is detected by monitoring the status of the digital asset. The metadata set includes some or all of header information of the digital asset and supplemental information including at least a location of the digital asset. The server is configured to maintain the metadata set but does not have an access to the digital asset, and is further configured to communicate with a computing device to receive an update to the metadata therefrom. The server is coupled to a public network while the computing device is coupled to a private network. Depending on implementation, the computing device may be a storage device, a local server or a client device.

According to yet another embodiment, the present invention is a software product stored in a memory space and executed on a server, for synchronizing digital assets, the software product comprises: program code for updating a metadata set of a digital asset when there is a change made to a status of the digital asset, and program code for causing a first computing device to retrieve a latest version of the digital asset from a second computing device when the digital asset is attempted for access by a user on the first computing device. The change is detected by monitoring the status of the digital asset, and the metadata set includes some or all of header information of the digital asset and supplemental information including at least a location of the digital asset. Further, the server does not have an access to the digital asset.

According to yet another embodiment, the present invention is a service provided by a service provider to synchronize digital assets owned by a plurality of entities. By offering an interface to a server operated by the service provider, the entities may define their own storage policy modules and access privileges for their users, register predefined storage areas and procedures when and how to effectuate the synchronization when a change is made to one of the digital assets.

One of the objects in the present invention is to provide a synchronization mechanism for all managed digital assets without releasing the content of the digital assets.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows a basic system configuration in which the present invention may be practiced in accordance with a preferred embodiment thereof;

FIG. 1B shows exemplary internal construction blocks of a computing device in which one embodiment of the present invention may be implemented and executed;

FIG. 2A shows a diagram of producing a metadata set for a managed file;

FIG. 2B illustrates an exemplary structure of a metadata set for a PDF file;

FIG. 2C illustrates an exemplary structure of a metadata set for a music file (e.g., song.mp3);

FIG. 3A shows a flowchart or process of synchronizing managed files via respective metadata thereof, where the process may be performed in software or in a combination of both software and hardware;

FIG. 3B illustrates that two computers being accessed by two users have two different allocations of managed folders on their computers;

FIG. 3C illustrates a series of changes made to a managed document on two different computers;

FIG. 4A shows a functional block diagram of a server device in which a server module resides in a memory space and is executed by one or more processors to facilitate the synchronization services described in the present invention; and

FIG. 4B shows a functional block diagram of a local computing device executing a client module to watch a status of a digital asset and report a status change when there is a change made to the digital asset.

### DETAILED DESCRIPTION OF THE PREFERRED EMBODIMENTS

The present invention is related to processes, systems, architectures and software products for synchronizing files that may be accessed anywhere at any time without releasing the content of the files. In one perspective, the content of a file stays where it is specified (e.g., a server within an organization or enterprise) but the file itself is synchronized via a sync service provided by an internal or external server.

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

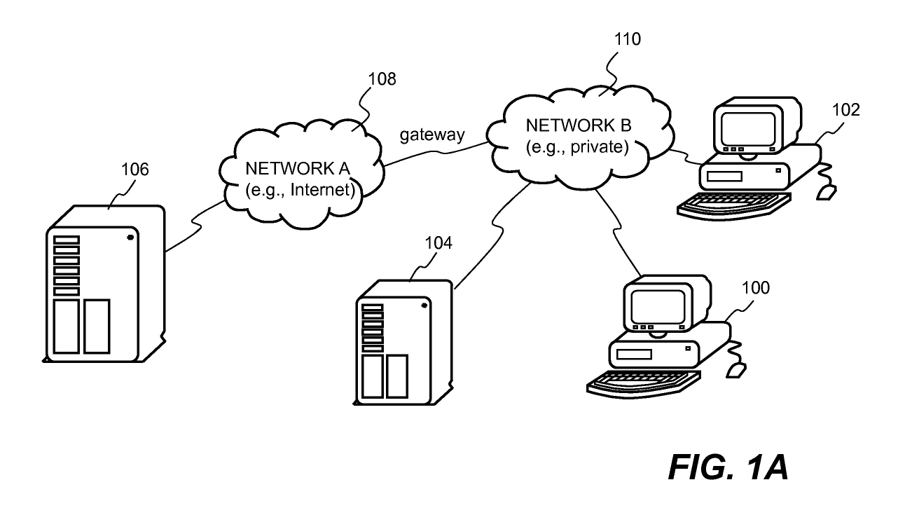

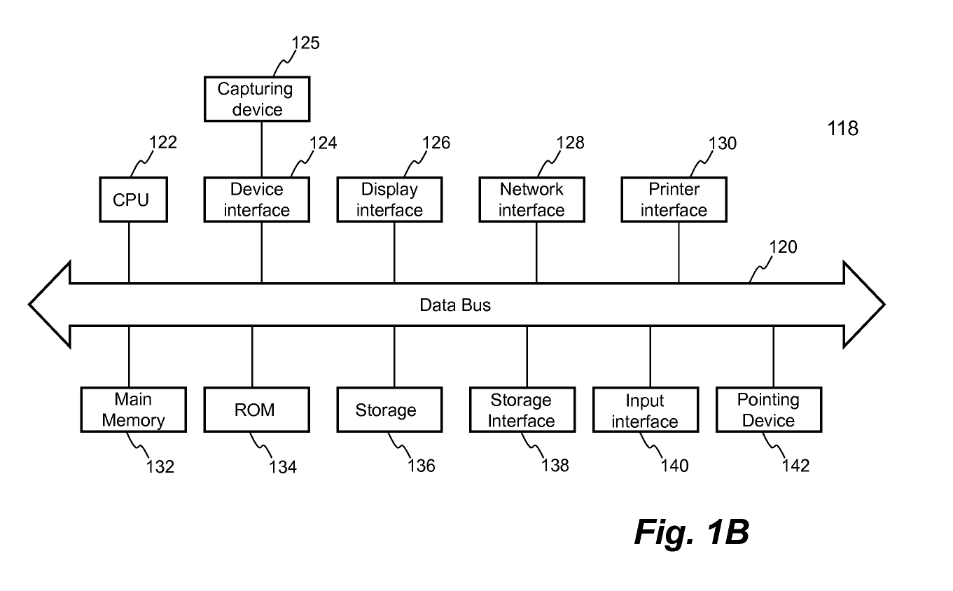

Embodiments of the present invention are discussed herein with reference to FIGS. 1A-4B. However, those skilled in the art will readily appreciate that the detailed description given herein with respect to these figures is for explanatory purposes as the invention extends beyond these limited embodiments.

To facilitate the description of the present invention, it deems necessary to provide definitions for some terms that will be used throughout the description herein. It should be noted that the definitions in the following are to facilitate the understanding and description of the present invention according to one embodiment. The definitions may appear to include some limitations with respect to the embodiment, the actual meaning of the terms has applicability well beyond the embodiment, which can be appreciated by those skilled in the art.

Digital Asset—defines a type of electronic data that includes, but is not limited to, various types of documents, multimedia data, streaming data, dynamic or static data, executable code, images and texts.

File or document—interchangeably used herein, indicates one type of digital asset and can be accessed by one or more applications without a priori knowledge, wherein an access to a file or document is a request that results in the file or document being opened, viewed, edited, played, listened to, printed, or in a format or outcome desired by a user who has requested the access to the file or document.

Managed file or managed document—interchangeably used herein, defines a type of digital asset that is managed for synchronization across a network, such a file or document can be updated from anywhere at any time under a defined or managed environment while an authorized user can always access the latest version (or revisions) from anywhere at any time within the managed environment, where a defined or managed environment is referred to an environment in which all files are managed for synchronization. An example of the environment is a plurality of computers each of which has at least one folder and executes a module monitoring what files are disposed in the folder, hence managed folder. All files in the folder shall be automatically managed by the module for synchronization.

Access privilege—is one or more rights a user may have with respect to a managed file or folder. A user may only be able to access a managed file or folder from a designated location if his/her access privilege limits him/her to do so. Optionally, access privilege may specify other limitations on a specific managed file or folder, for example, a file transfer protocol, an access application (model and/or version), a permit to grant access privilege to others (e.g. a consultant) or membership in other groups, etc.

Client device, computer, or machine—interchangeably used herein, is a terminal device typically used by a user to access managed documents.

Server device, computer, or machine—interchangeably used herein, is a computing device. In one embodiment, such a computing device is configured to provide synchronization service for managed files that are created in or accessible from a client machine.

Client module—generally means a version of one embodiment of the present invention and typically is loaded in a client device to deliver functions, features, benefits and advantages contemplated in the present invention. In the context of the present invention, the client module is configured to monitor or track the status of a managed file and any revisions that may have happened to the file. To facilitate the description of the present invention, the client module is also referred to herein as an agent or a monitoring module.

Server module—generally means a version of one embodiment of the present invention and typically is loaded in a server device to deliver functions, features, benefits and advantages contemplated in the present invention. In the context of the present invention, the server module is configured to communicate with the client module to consolidate or synchronize the statuses of a managed file and any revisions that may have happened to the file on one or more client devices. To facilitate the description of the present invention, the server module is also referred to herein as a sync module. A server device is configured to execute the sync module to provide file synchronization management, hence a sync manger.

Server and Client—unless otherwise specifically or explicitly stated, a server may mean either a server machine or a server module, a client may mean either a client machine or a client module, and in either case, the particular meaning shall be evident in the context.

FIG. 1A shows a basic system configuration in which the present invention may be practiced in accordance with one embodiment thereof. Documents or files, such as product descriptions, customer lists and price schedules, may be created using an authoring tool executed on a client computer 100 that may be a desktop computing device, a laptop computer, or a mobile computing device. Exemplary authoring tools may include Microsoft Office (e.g., Microsoft Word, Microsoft PowerPoint, and Microsoft Excel) and Adobe Photoshop.

According to one embodiment, the client computer 100 is loaded with a client module that is a linked and compiled, or interpreted, version of one embodiment of the present invention and is capable of communicating with a server 104 or 106 over a data network (i.e., the Internet or a local area network). According to another embodiment, the client computer 100 is coupled to the server 104 through a private link. As will be further explained below, a document created by an authoring tool is managed by the client module that will be further described in detail below. The client module, when executed, is configured to monitor the status of a managed document as long as it is disposed in a predefined storage area (e.g., a pre-allocated data repository) or simply a managed folder.

By virtue of the present invention, documents stored in a managed folder can be accessed by users as usual, but any changes or updates to any of the managed documents are synchronized. In other words, a file being edited at one place can be continued at another place without having to carry a version of it. In one embodiment, access privilege or access privileges may also be placed on a file or a folder. The access privilege for a user may include, but not be limited to, a viewing permit, a copying permit, a printing permit, an editing permit, a transporting permit, an uploading/downloading permit, and a location permit.

In one embodiment, a document may be created on the client computer 100 and shared as a copy on a client computer 102. The copy is stored in a managed folder in the client computer 102, resulting in the copy of the document being managed. The copy is further uploaded from the client computer 102 via the network 110 to a computing or storage device 104 that may serve as a central repository managed by an IT department at an enterprise. Upon arriving in the repository, the document becomes managed, namely its status, revisions and whereabouts and other information about the document (but not the content thereof) are tracked or managed at a central location (e.g., the sync manager running on a server 106). Should the document be copied to another computer running a similar client module, the location of the computer and any changes or revisions made to the document are also tracked to allow authorized users to know what has happened to the document and where copies of the document have been distributed.

Although not necessary, the network 110 is preferably a private or secured link. Such a link may be provided by an internal network within an enterprise, or a secured communication protocol (e.g., VPN and HTTPS) is used over the Internet. Alternatively, such a link may be simply provided by a TCP/IP link. As such, managed files on any of computing devices on the network 110 may be remotely accessed and synchronized via the sync manager.

According to one embodiment, the storage device 104 is coupled to or part of a server executing a client module or a local version of a server module of one embodiment of the present invention. One of the key features, advantages and objectives in the present invention is to synchronize all managed files via a server without having to release the files to the server. The storage device 104 is provided to keep a latest version of a file, although there are copies of the file distributed on several computers on the private network 110. It can be appreciated that not every copy of the file is updated depending upon whether a particular computer is up running at the time a change is made to the file. The storage device 104 is configured to be up running and communicate with the server 106 to ensure all managed files are synchronized.

Coupled to a public network 108, the server 106 executes a server module (i.e., a sync manager) to provide file synchronization management for one or more organizations or business entities. As will be further explained below, the server module in the server 106 maintains or interfaces to a database that includes, but is not limited to, a list of organizations, corresponding access privileges for an entire organization, rules for folders or files. One of the key features, advantages and objectives in the present invention is that the sync manager is configured to synchronize the managed files using their respective metadata thereof. In any event, managed files are kept behind a firewall or always under the control of an entity (e.g., an enterprise). In other words, the content of the managed files will not be released to anyone other than the authorized users within an enterprise.

FIG. 1B shows exemplary internal construction blocks of a computing device 118 in which one embodiment of the present invention may be implemented and executed. The device 118 may correspond to a client or a server device (e.g., computer 100, 102, 104 or 106 in FIG. 1A). It can be appreciated by those skilled in the art that not all of the blocks have to be in one device, neither all of the blocks are needed to practice the invention. As shown in FIG. 1B, the device 118 includes a central processing unit (CPU) 122 interfaced to a data bus 120 and a device interface 124. CPU 122 executes instructions to process data and perhaps manage all devices and interfaces coupled to data bus 120 for synchronized operations. The instructions being executed can, for example, pertain to drivers, operating system, utilities or applications. A device interface 124 may be coupled to an external device, such as the computing device 102 of FIG. 1A or a camera (not shown), hence, the managed documents or photos therefrom can be received into memory 132 or storage 136 through data bus 120. Also interfaced to data bus 120 is a display interface 126, a network interface 128, a printer interface 130 and a storage interface (e.g., a USB) 138. Generally, a client module or a server module of an executable version of one embodiment of the present invention can be stored in the storage 136 through the storage interface 138, network interface 128, device interface 124 or other interfaces coupled to data bus 120. Execution of such a module by CPU 122 can cause the computing device 118 to perform functions as desired in the present invention. In one embodiment, the device interface 124 provides an interface for communicating with a capturing device 125 (e.g. a finger print sensor, a smart card reader or a voice recorder) to facilitate the authentication of a user of the computing device 118.

Main memory 132, such as random access memory (RAM), is also interfaced to data bus 120 to provide CPU 122 with instructions and access to memory storage 136 for data and other instructions. In particular, when executing stored application program instructions, such as a synchronizing module in the present invention, CPU 122 is caused to manipulate the data to achieve results contemplated by the present invention. Read-Only Memory (ROM) 134 is provided for storing executable instructions, such as a basic input/output operation system (BIOS) for operation of input interface 140, display 126 and pointing device 142, if there are any.

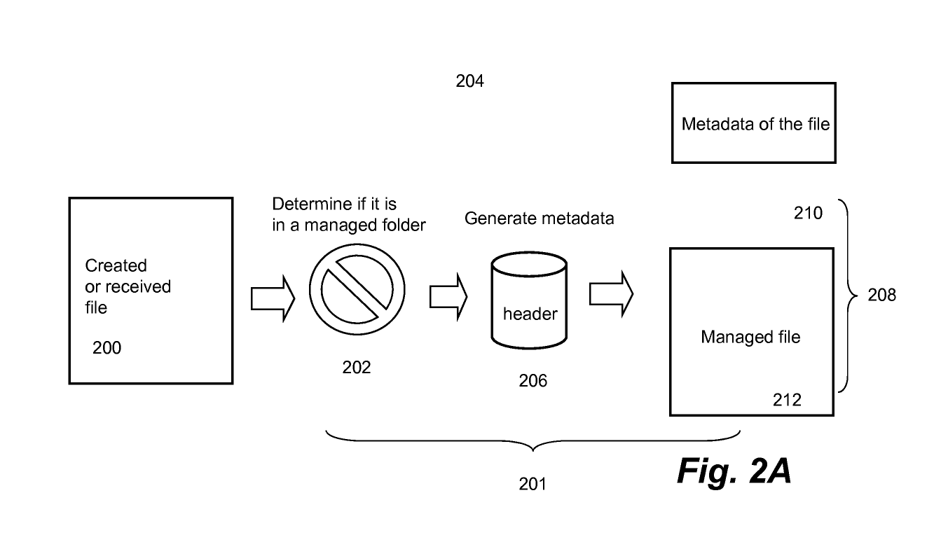

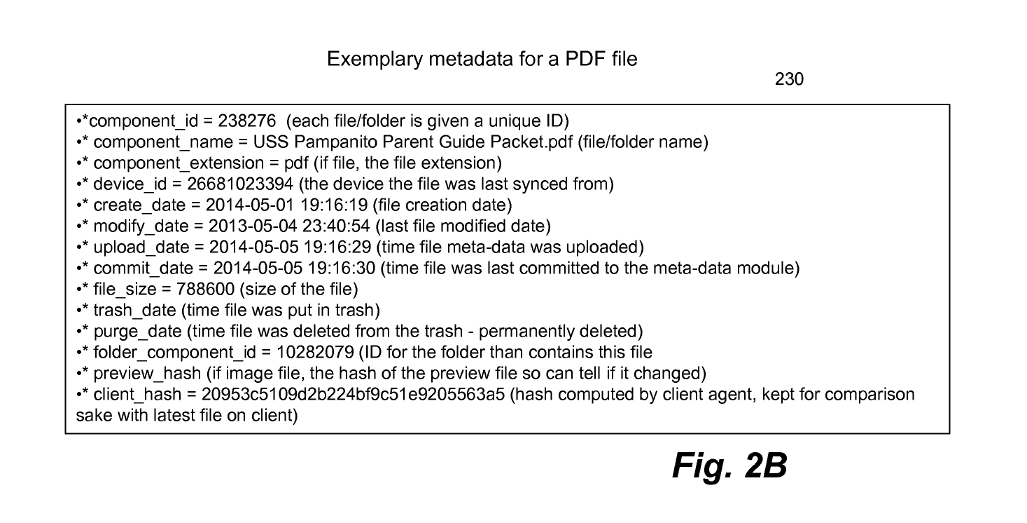

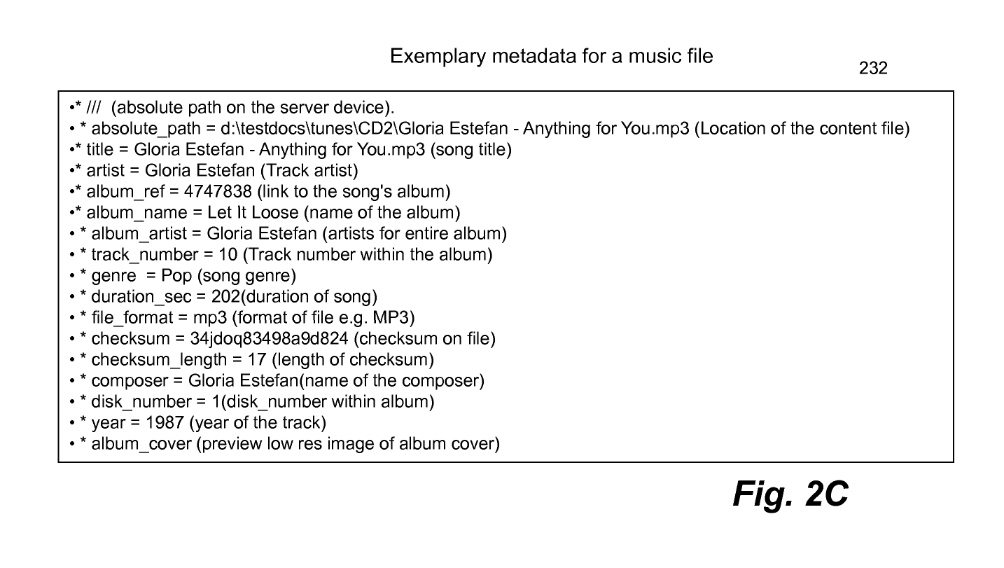

Referring now to FIG. 2A, an illustration of generating metadata about a managed file 200 is shown. After a file 200 is created with an application or authoring tool (e.g., Microsoft WORD) or received from a source (e.g., a USB drive, an email or a network), upon activating “Save,” “Save As” or “Close” command or automatic saving invoked by an operating system (OS), an application itself, or an application that is previously registered with a server, the file 200 is caused to undergo a synchronizing process 201. The synchronizing process 201 starts with a detection process 202, namely the file 200 is being written into a defined store, where the store is being monitored by a client module configured to track the status of all files therein. The detection process 202, as will be further detailed below, is a process to detect if the file is being saved into a managed store (e.g., a folder).

Once the file is disposed into the store, the header information of the file is extracted. Many file types can be identified by using what is known as a file header. A header is a unit of information that precedes a data object (content), so an operating system and other software know what to do with the following contents. It is a region of each file where bookkeeping information is kept and may include, depending on a file format, a file name, the date the file was created, the date it was last updated, the file size, a geographic information or other relevant information. At 206, a data set, referred to as metadata, of the file is produced or updated, where the metadata includes some or all of the header information and supplemental information prepared by the module. Depending on the implementation, the supplemental information may include where the file was initially located, who created it or has updated it, how many copies it has had and where the distributed copies are located.

Essentially, as shown in FIG. 2A, a managed file creates two parts, the metadata of the file 210 and the content of the managed file 212 (e.g., the file itself). To access the managed file 212, one is caused to access the metadata. One of the features in the present invention is that the managed file 212 is always kept within an organization (i.e., only on the internal network 110 of FIG. 1A) while the metadata can be saved in a server on a public network (e.g., the server 106 of FIG. 1A). In other words, all managed files are synchronized by a synchronization management server without having to be loaded to the server. At the same time, the operation of any of the files is transparent to a user.

Alternatively, a file in a managed folder appears substantially similar but not identical to a regular file (unmanaged). For example, icons or file names of managed documents may appear in a different color or with a visual indication to distinguish from non-managed files. According to one embodiment, such an indication is controlled by the client module. When a managed file or a copy thereof is ended up in a machine or readable medium (e.g., an unmanaged folder, CD or USB), the synchronization of the managed file or the copy would be lost.

According to one embodiment, sets of files/folders are logically kept in collections and referred to as datasets. These datasets are in essence the container (e.g., managed folder) of a particular set of files and folders.

Exemplary Information for a Dataset (or a Folder) in a Set of Metadata:
a) dataset_id—id of the dataset;
b) dataset_location—location where the dataset is stored, this typically is a key into a location table, a location could be an identifier (as a parameter)) device_id) of the device a managed file is stored on, or an URL that points to a 3rd party storage device;
c) user_id—id of user who owns the dataset;
d) dataset_name—the symbolic name of the dataset;
e) dataset_state—one of the statuses: active, suspended and deleted;
f) last_dataset_version—keep track of the version of the dataset; any change to content causes the version number to increase, which makes it easier to notify client devices of the changes at the granularity of a dataset; the local agent (a module) on the device can then determine if it is interested in this dataset and its changes and take appropriate action if that is indeed the case.

It shall be noted that a dataset may have versions. Managed files and folders may have versions as well. A revision history of a particular file or folder is maintained via the metadata. Depending on the storage policy in place for the dataset, all revisions of a file, only a fixed number of the latest versions (e.g. last 3 versions) or just the latest version can be kept. In one embodiment, a record of the entire history of a file is kept so that it is possible to tell who has modified the file, when and where the file has been modified.

Exemplary Information that is Maintained for Revisions:
component_revision—holds the version this record of the component (file/folder) represents
Metadata storage—can choose to maintain records for multiple versions, if so desired; or it could just keep the latest version only, depending upon how the storage policy is setup.

For image files, according to one embodiment, preview versions and thumbnail versions of the files may be maintained. These files are generated by services on the server or a client device in the cloud associated with the metadata storage.

### a) For Preview Images

Content_object—can hold ancillary data for a component (e.g. preview image of a photo file)

### b) For Thumbnail Images

Thumbnails can be stored in the same way as preview images, where the metadata has a pointer to the thumbnail image

According to one embodiment, file sharing is tracked so that the synchronization management knows exactly how a managed file has been shared. Links to locations of the managed file or copies thereof are tracked in the metadata. Such a link allows us to specify for a user a component which is really a symbolic link to another component that could actually be owned by another user. These links between components allow the sync manager to share items (files/folders) between users.

In one embodiment, there are 2 special datasets for a user:

i) Shared By Me Dataset—holds the components that the user has shared with other users; and
ii) Shared To Me Dataset—holds the components that other users have shared with this user.

For example, when a photo is shared with another user

i) A new entry in the Shared By Me Dataset will be created with:
component_id—to identify the shared item
revision—revision of the shared item
name=name of the item
content_url—URL used to retrieve the item
preview_url—URL that points to the preview image of the item
opaque_metadata—holds name/value pairs that are stored and used by the clients but not interpreted by the Metadata Server
e.g. photo album name, sharer's name
recipient_list—list of users that the photo was shared with
   ii) A new entry in the Shared With Me Dataset for each recipient will be created with:
component_id—to identify the shared item
revision—revision of the shared item
name=name of the item
   In this case the component is in fact a link to the actual component in the Shared By Me Dataset of the sharer.

FIG. 2B illustrates an exemplary structure of a metadata set 230 for a PDF file. It includes the header information from the PDF file, such as when the file was created and when it was modified last time, and supplemental data generated from the status of the file, such as when the file became a managed file (namely when the file was dropped into a managed folder) and in which managed folder (i.e., folder identifier) the file resides.

FIG. 2C illustrates an exemplary structure of a metadata set 232 for a music file (e.g., song.mp3). It includes some or all of the header information from the mp3 file, and supplemental data generated from the status of the file. Different from a word file authored with Microsoft WORD, the header information of an mp3 file includes information on genre, file format, composer, album and etc. while the supplemental information of the file includes a direct path to a storage location of where the file resides.

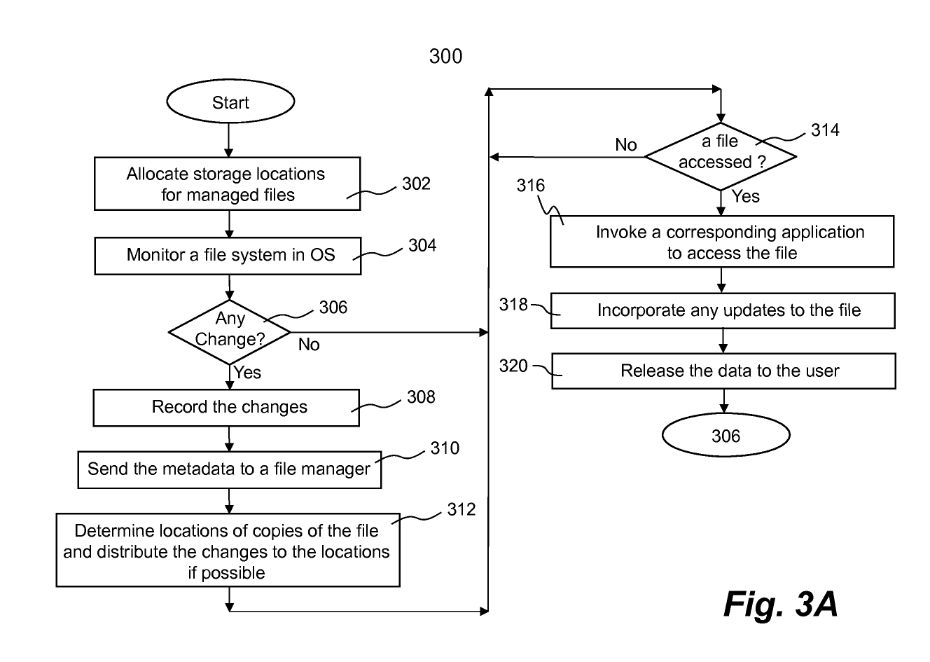

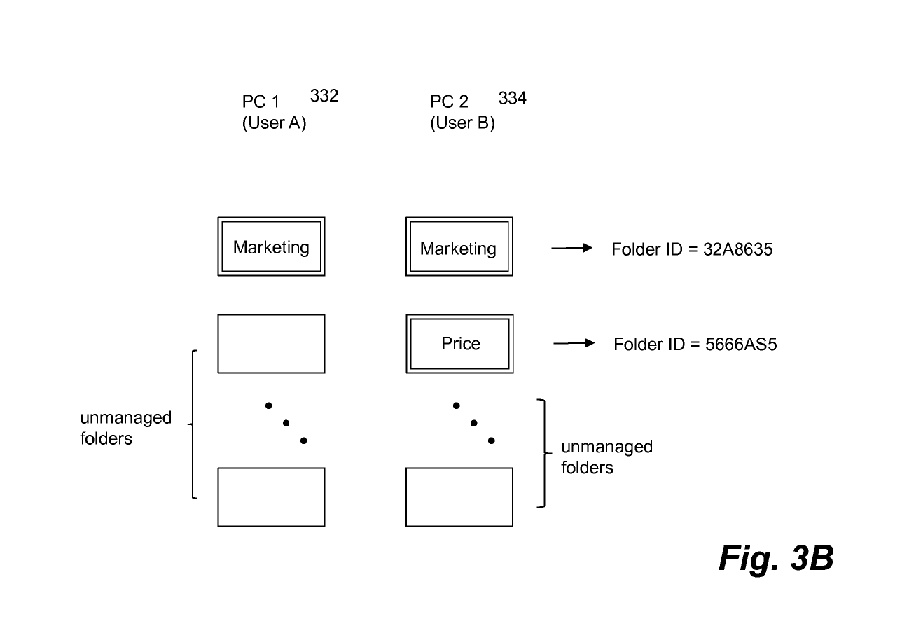

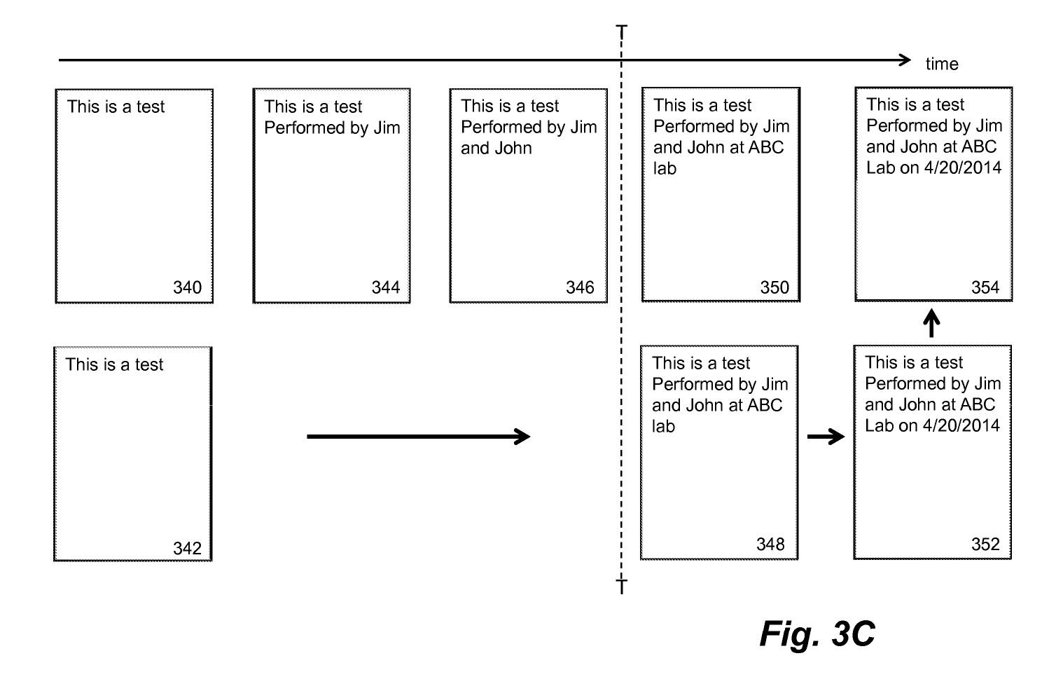

FIG. 3A shows a flowchart or process 300 of synchronizing managed files via respective metadata thereof. The process 300 may be performed in software or in a combination of both software and hardware, and may be understood in conjunction of previous figures.

At 302, one or more managed storage locations are allocated to keep files therein synchronized. According to one embodiment, at least one folder is allocated on one or more of the computing devices on a private network so that files in the managed folder may be cooperatively worked and synchronized. Depending on implementation, certain users may be authorized to access some of the managed folders while a group of users may be authorized to access all managed folders. The access controls of the users are managed by respective granted privileges.

Referring now to FIG. 3B, it illustrates that two computers being accessed by two users have two different allocations of managed folders on their computers 332 and 334. On the computer 332, there is a managed folder named “Marketing” while there are two managed folders “Marketing” and “Price” on the computer 334. In operation, files in Marketing folders (with same identifier) are synchronized. When User A makes some updates (e.g., editing) to a file in the Marketing folder, User B sees the updates when User B accesses the file. This file synchronization is performed via the metadata of the file on a server (e.g., the server 106 of FIG. 1A) without having the file leave the private network.

It can be noted that the computer 334 is allocated an extra managed folder named “Price” in view of the computer 332. In one embodiment, storage allocation is done based on the granted access privileges for each of the users in an enterprise. User B uses the folder “Price” to synchronize files therein with other users authorized to access the folder “Price”. In one embodiment, each of the managed folders is assigned an identifier (e.g., using an alphanumeric code or characters) that is included in the metadata of a file therein so that the server knows where the file is located.

Referring now back to FIG. 3A, the managed folder is monitored by a client module to determine if there is any change to a file there at 304. According to one embodiment, Windows File Monitoring API is used to register a callback function, called file change notification. The process 300 now goes to 306 to monitor a managed folder or folders. When any change happens at 306 to the file system, the callback function is invoked. In another embodiment, the java.nio.file package provides a file change notification API, called the Watch Service API. This API allows a directory or directories (i.e., a folder or folders) to be registered with the watch service. When registering at 304, one or more types of events may be specified, such as file creation, file deletion, or file modification. When the service detects an event of interest, it is forwarded to the registered process. The registered process has a thread (or a pool of threads) dedicated to watching for any events it has registered for. When an event comes in at 306, it is handled as needed.

The process 300 goes to 314, waiting for the file to be accessed if there is no change to the file at 306. It is assumed now that there is a change to a managed file at 306. The process 300 now goes to 308 to record the change. As described above, the managed file is processed by the client module to produce the metadata thereof by extracting some or all of the header information along with supplemental information generated about the file. Depending on implementation, the metadata may be sent to the server in its entirety or only a difference between the updated metadata and a previous version thereof is sent to the sync manager running on the server at 310. It shall be noted that the server on a private network or the Internet receives the metadata, not the managed file itself. In one embodiment, a latest version of the file is kept on a storage device on the private network in an enterprise.

At 312, the server is configured to determine the location of the managed file. There are cases in which several users are cooperatively working on the managed file. Any changes to the managed file shall be reflected on the copies thereof distributed on other computers. It is assumed herein that the server has already invoked to synchronize the file, hence a metadata set is already there and constantly updated. Given the updated metadata, the server knows where the file or copies thereof reside. The updated metadata or changes thereto are distributed to those locations (i.e., computing devices each running a client module) to incorporate the changes made by the user or users to the file or the copies.

The functions are performed based on the assumption that the network is up running. In an event in which the connection to one of the computing devices is not available, the server is configured to record the event and accumulate the changes and subsequent changes to the managed file if any, and deliver the changes in metadata to the computing device to effectuate the changes all together to the managed file.

It is often the case in which a copy of the file in a managed folder allocated on another computer is not being worked on. During the period that the copy is not being worked on, there are changes made to the file on other computers. When the copy of the file is accessed at 314, a corresponding application is invoked to access the file. For example, xxx.doc would invoke Microsoft WORD application to open the file. At 318, changes made to the file on other computers are incorporated by the corresponding application before the file becomes available to the user at 320. Alternatively, a latest copy of the file is transferred from a storage device (e.g., the storage device 104 of FIG. 1A) to be used in the corresponding application.

Referring now to FIG. 3C, it illustrates a series of changes made to a managed document on different computers. It is assumed a document 340 is initially created on a computer A and saved into a managed folder on computer A and meanwhile a copy of the document on computer B, hence creating a first set of metadata that is transported to a server (e.g., the server 106 of FIG. 1A). The metadata records when and where the document was initially created and who created it and further a folder identifier. As soon as a copy 342 of the document 340 is sent as an attachment, uploaded to computer B via FTP or via a USB drive and received in computer B, the metadata for the document is updated and records that there are two copies of the document and their respective locations (e.g., the identifiers of the two computers or network addresses of the two computers).

It is assumed that the user of computer B did not do anything with the document 342 till a time T. Before the time T, the user of computer A has updated the document a few times to reach a version 346. Accordingly, the corresponding metadata has been updated several times. At the time T, the user of computer B decided to access the copy of the document in computer B. Before the document can be opened for use, the corresponding metadata is received or checked with (e.g., from the server or already received in computer B) to indicate that the document has been updated several times, instead of opening the version 342, the latest version 346 is opened. Depending on implementation, the latest version 346 may be obtained from a central repository (e.g., the storage device 104 of FIG. 1A) or the changes are incorporated in updating the document 342 to document 346. At the moment T, the user of computer B now has the version 346 to work with and updates the version 346 to a version 348.

The metadata has been updated from computer B. In one embodiment, the central repository has the updated version that may be obtained by computer A when computer A is caused to access the document. After the moment T, both computers A and B now have the identical versions 348 and 350, namely the documents 348 and 350 are synchronized without the server receiving any of the document 340 or its revisions 344, 346 or 348. As the user of computer B continues to work on the document 348 to update it to version 352, updated metadata is sent to the server. Under the supervision of the server, computer A is caused to update the document 350 to the updated version 354. At the moment, both documents 352 and 354 on two different computers are synchronized.

The above description indicates that a central repository or storage server is used to keep the latest version of a document for a client device to retrieve it when the client device is caused to access a local version of the document. It can be appreciated by those skilled in the art that any of the client devices may be designated as a repository to keep the latest version of a document.

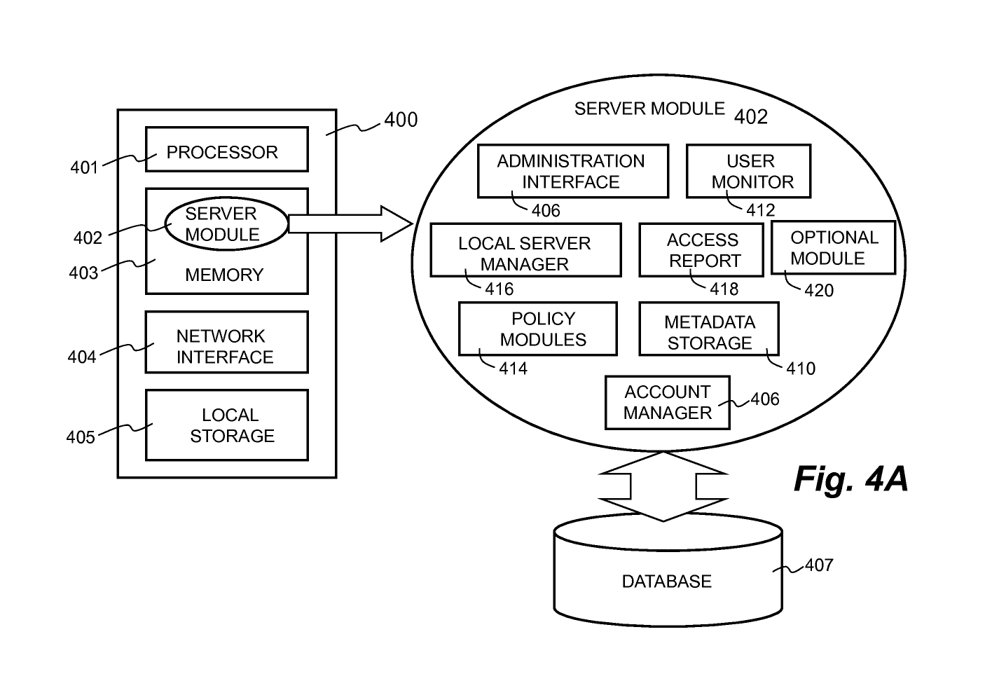

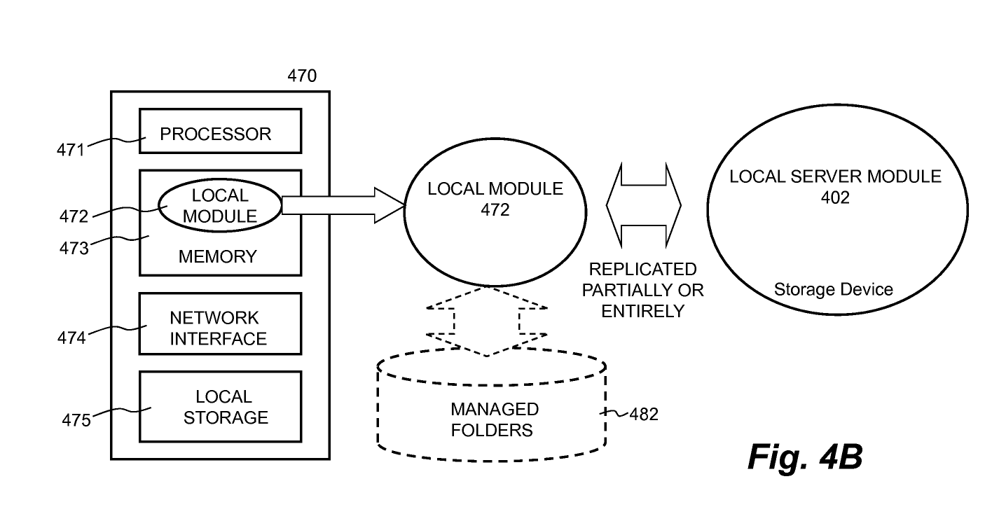

Referring now to FIG. 4A, there is shown a functional block diagram of a server device 400 in which a server module 402 resides in a memory space 403 and is executed by one or more processors 401 to facilitate the synchronization services. The server device 400 also includes a network interface 404 to facilitate the communication between the server 400 and other devices on a network and a local storage space 405. The server module 402 is an executable version of one embodiment of the present invention and delivers, when executed, features/results contemplated in the present invention. According to one embodiment, the server module 402 comprises an administration interface 406, an account manager 408, metadata storage 410, a user monitor 412, a policy modules manager 414, a local server manager 414, an access report manager 418, and an optional module 420. It can be appreciated to those skilled in the art that not all of the modules have to be included in order to achieve the synchronization functions by the server module 402. For example, a localized version of the server module to synchronize digital assets for only one enterprise shall need fewer modules than a full server module configured to provide the synchronization services for several enterprises.

### Administration Interface 406:

As the names suggests, the administration interface 406 facilitates a service provider to register users and grant respective access privileges to the users and is an entry point to the server module. In one embodiment, the administration interface 406 is provided for a system administrator of an enterprise to set up hierarchy access levels for various managed folders, storage locations, users or group of users. For example, one user may be an executive or a branch supervisor who has the access privileges to any managed folders or storage locations. Others have limited access privileges and can access certain managed digital assets. The privileges may include, but not be limited to: open, edit, write, print, copy, download and others. Examples of the other privileges may include: altering access privileges for other users, accessing managed files from one or more locations, and setting up a set of access rules for a managed folder for a group of users. According to one embodiment, the administration interface 406 is a user graphic interface showing options for various tasks that an authenticated system administrator or operator may need to perform in order to synchronize managed digital assets within an enterprise.

### Account Manager 408:

Essentially, the account manager is a database or an interface to a database 407 (e.g., an Oracle database) maintaining all the registered organizations subscribing the synchronization services provided by a service provider operating the server 400, and their respective access privileges, and perhaps corresponding links to policy modules. In one embodiment, the account manager 408 authenticates a user when the user tries to access a managed digital asset and also determines if the user may access managed digital assets from the location the user is currently at. In general, the account manager 408 is provided for an enterprise to control its users.

### Metadata Storage 410:

This is a predefined storage area to maintain metadata sets for all managed digital assets. Depending on implementation, metadata sets may be grouped and maintained for all managed digital assets in one folder and updated all together whenever there is a change to anything in the folder or the metadata sets may be individually managed and updated only when there is a change to a corresponding digital asset (e.g., a WORD file). In one embodiment, the metadata set is maintained in a markup language (e.g., XML). In another embodiment, the metadata is kept in a database.

### User Monitor 412:

This module is configured to monitor an access request from a user and his/her access location. In one embodiment, a user is granted to access the managed digital assets from one or more designated locations or networked computers. Should the user access a managed file from an unknown location (e.g., unrecognized IP address or unauthorized computer), the user monitor 412 may be configured to deny the access.

### Policy Modules Manager 414

This manager is provided to keep a storage policy module for an organization. For example, when a user requires to access a file while several devices have such a file, the storage policy by one organization may specify that the one closer to the requesting computer in terms of geographic distance is caused to service the access request, which is particularly efficient when an organization operates on several countries. Similarly, the storage policy by one organization may also specify that the one having the most available resources in terms of bandwidth and computing power at the moment shall service the access request, which is particularly efficient when an organization has a larger number of employees at a location.

### Local Server Manager 416:

This module is designed to be responsible for distributing an appropriate local module for a local server servicing a predetermined location or a predetermined group of users. According to one embodiment, the local server manager 414 replicates or customizes some of the server module 402 and distributes a localized version to an enterprise, where the localized version is executed on a server on a private network. For example, it can be loaded on the server 104 of FIG. 1A. As a result, all digital assets may still be managed and synchronized on the private network without the server 106.

### Access Report Manager 418:

This module is configured to record or track all access activities (successful or attempted) and primarily works with respective client modules running on client machines. The access report manager 418 is preferably activated by a system administrator and the content gathered in the access report manager 418 shall be only accessed by the system administrator or with authority.

It should be pointed out that the server module 402 in FIG. 4A shows some exemplary modules according to one embodiment of the present invention and not every module in the server module 402 has to be implemented in order to practice the present invention. Those skilled in the art can understand that given the description herein, various combinations of the modules as well as modifications thereof without departing the spirits of the present invention, may achieve various desired functions, benefits and advantages contemplated in the present invention.

FIG. 4B shows a functional block diagram of a local computing device 470 that may correspond to the devices 100, 102 and 104 of FIG. 1A. Operationally, the local device 470 is generally similar to that of a server as illustrated in FIG. 4A. Accordingly, many parts illustrated in FIG. 4B are not to be described again to avoid obscuring aspects of the present invention. As shown in FIG. 4B, the local device 470 executes a client module 472 configured to monitor the status of a managed digital asset managed folders 482, and communicates with the server module to update the metadata therein.

As described above in one embodiment, a localized version 402 of the server module may be obtained and loaded on one of the computers (e.g., the server/storage device 104 of FIG. 1A) to synchronize the managed digital assets. As such, all authentication requests/synchronization can be handled locally or within the control of the enterprise. As another feature of utilizing the localized version 402 is that all managed digital assets are not affected if there is a disruption in connection to the central server on the internet. Alternatively, more than one local servers are used and each executes a local server module, the reliability of servicing the users is greatly enhanced.

The present invention may be implemented as a method, a system, a computer readable medium, a computer product and other forms that achieve what is desired herein. Those skilled in the art will understand that the description could be equally applied to or used in other various different settings with respect to various combinations, embodiments or settings provided in the description herein.

The processes, sequences or steps and features discussed above are related to each other and each is believed independently novel in the art. The disclosed processes, sequences or steps and features may be performed alone or in any combination to provide a novel and unobvious system or a portion of a system. It should be understood that the processes, sequences or steps and features in combination yield an equally independently novel combination as well, even if combined in their broadest sense, i.e., with less than the specific manner in which each of the processes, sequences or steps and features has been reduced to practice.

The forgoing description of embodiments is illustrative of various aspects/embodiments of the present invention. Various modifications to the present invention can be made to the preferred embodiments by those skilled in the art without departing from the true spirit and scope of the invention as defined by the appended claims. Accordingly, the scope of the present invention is defined by the appended claims rather than the foregoing description of embodiments.

We claim:

1. A method for synchronizing digital assets via a server device, the method comprising:
updating a metadata set of a digital asset when there is a change made to a status of the digital asset, wherein the change is detected by monitoring the status of the digital asset, and the metadata set includes some or all of header information of the digital asset and supplemental information including at least a location of the digital asset; and
synchronizing the digital asset via the metadata set without releasing a copy of the digital asset to the server device.

2. The method as recited in claim 1, wherein the server is on a public network, and the status of the digital asset is being monitored by a client module running on each of computing devices coupled to a private network.

3. The method as recited in claim 2, wherein at least a first device and a second device each have the digital asset, the supplemental information of the digital asset including identifiers respectively identifying the first and second devices.

4. The method as recited in claim 3, wherein said synchronizing the digital asset via the metadata set comprises:
causing the digital asset in the first device to be automatically updated when the digital asset in the second device has been updated.

5. The method as recited in claim 4, further comprising:
maintaining a policy module to determine how to cause the first device or the second service to service a request to access the digital asset.

6. The method as recited in claim 5, wherein a decision to cause the first device or the second service to service the request to access the digital asset is based on one or more of: respective geographic distances of the first and second devices to the requesting device, and available computing resources of the first and second devices at the time the request was made by the requesting device.

7. The method as recited in claim 3, further comprising:
allocating a predefined storage area for storing the digital asset;
registering an identifier identifying the predefined storage area; and
generating metadata for each of the digital assets moved into the predefined storage area, wherein the metadata for the each of the digital assets includes the identifier.

8. The method as recited in claim 7, wherein the predefined storage area is a folder or a repository.

9. The method as recited in claim 8, wherein said updating a metadata set of a digital asset comprises: expanding the metadata to include another identifier when a copy of each of the digital assets is made into another folder identified by the other identifier.

10. The method as recited in claim 9, wherein said synchronizing the digital asset via the metadata set comprises:
receiving the change to the each of the digital assets in the folder; and
causing each of the digital assets in the folder in another folder to be updated with the change.

11. The method as recited in claim 1, wherein each of the digital assets is an electronic file in a file format with header information.

12. A system for synchronizing digital assets, the system comprising:
a server configured to update a metadata set of a digital asset when there is a change made to a status of the digital asset, wherein the change is detected by monitoring the status of the digital asset, and the metadata set includes some or all of header information of the digital asset and supplemental information including at least a location of the digital asset, the server is configured to maintain the metadata set but does not have an access to the digital asset, and is further configured to communicate with a computing device to receive an update to the metadata therefrom.

13. The system as recited in claim 12, wherein the server is coupled to a public network while the computing device is coupled to a private network.

14. The system as recited in claim 13, wherein the computing device is a client device used by a user to make the change to the digital asset.

15. The system as recited in claim 14, wherein the client device is executing a client module configured to monitor a status of the digital asset and send an update to the server when the status of the digital asset is updated.

16. The system as recited in claim 15, wherein the server is configured to update the metadata set when a copy of the digital asset is created, the metadata includes an indication where the copy of the digital asset is located.

17. The system as recited in claim 13, wherein the computing device is an internal repository to keep a latest version of the digital asset when the digital asset has been changed on a client device coupled to the internal network.

18. The system as recited in claim 17, wherein the server is configured to cause the latest version of the digital asset to be always used when another client device is caused to access the digital asset.

19. A software product, stored in a memory space and executed on a server, for synchronizing digital assets, the software product comprising:
program code for updating a metadata set of a digital asset when there is a change made to a status of the digital asset, wherein the change is detected by monitoring the status of the digital asset, and the metadata set includes some or all of header information of the digital asset and supplemental information including at least a location of the digital asset; and
program code for causing a first computing device to retrieve a latest version of the digital asset from a second computing device when the digital asset is attempted for access by a user on the first computing device, wherein the server does not have an access to the digital asset.

20. The software product as recited in claim 19, wherein the server is on a public network, and the status of the digital asset is being monitored by a client module running on each of the first and second computing devices coupled to a private network.

21. The software product as recited in claim 20, further comprising: program code for maintaining a policy module to determine how to service a request from the first computing device when the user attempts to access the digital asset, wherein the second computing device is determined by the policy module from a plurality of client computing devices each of which includes a copy of the latest version of the digital asset.

22. The software product as recited in claim 21, wherein the policy module is pertaining to a geographic distance between the first and second computing devices and available computing resources at a time the request is created.

23. The software product as recited in claim 22, wherein the first computing device is a storage device designated to keep a latest version of some or all of managed digital assets for an enterprise.

24. The software product as recited in claim 21, wherein the software product is controlled by a service provider in a business to provide synchronization services for all business entities.
